(19) United States
(12) Patent Application Publication
(10) Pub. No.: US 2021/0271114 A1
(43) Pub. Date: Sep. 2, 2021

(54) GLASSES WITH FUNCTIONS OF POSITIONING AND REMINDING

(71) Applicant: HSIEN CHANG OPTICAL INDUSTRIAL CO., LTD., Tainan (TW)

(72) Inventor: WEN-HSIUNG CHOU, TAINAN (TW)

(21) Appl. No.: 16/802,925

(22) Filed: Feb. 27, 2020

(51) Int. Cl. G02C 9/00; G02C 11/00

(52) U.S. Cl. CPC G02C 9/00; G02C 2200/02; G02C 11/00

(57) ABSTRACT

A pair of glasses with functions of positioning and reminding is revealed. The glasses include a frame, a first temple and a second temple pivotally connected to two sides of the frame. The first and the second temples include inner surfaces facing each other and outer surfaces opposite to the inner surfaces. A magnetic member is mounted on the outer surface while a striking-and-reminding gel-like member is integrally wrapped on the inner surface by injection. An upper edge and a lower edge of the striking-and-reminding gel-like member are respectively extending to form an upper segment and a lower segment which are respectively wrapped on the top surface and the bottom surface. Thereby the glasses can be attached to equipment made of iron at a workplace by the magnetic member and users can find them easily and quickly due to the striking-and-reminding gel-like member.

### BACKGROUND OF THE INVENTION

### Field of the Invention

The present invention relates to a pair of glasses, especially to a pair of glasses with functions of positioning and reminding, which able to be securely positioned on equipment made of iron at a workplace for attracting users' attention and making the glasses easy to find.

### Description of Related Art

Generally, glasses or different purposes available on the market now have different structures. Eye injuries are commonly seen at the workplace. In order to avoid workplace eye injuries, safety measures and certain methods for protecting eyes are necessary. Users need to wear protective eyewear to comply with the safety regulations and protect eyes from hazardous substances such as splashed granules, splattered chemicals, or ultraviolet light, visible light, infrared light in electromagnetic waves, etc.

However, there is a plurality of aids and parts at the workplace besides work-related equipment so that the workplace is often cluttered and messy. Moreover, the protective eyewear is usually used while working and is taken off for the rest of time. Thus the gasses are on and off many times during the work. The glasses taken off are always not in place or mixed with aid tools. Thus lenses on the glasses may be worn and hence the clarity is affected. The glasses are also difficult to find when users need them. This causes trouble in use and storage.

Thus there is room for improvement and there is a need to provide a pair of novel glasses that overcomes the above shortcomings.

### SUMMARY OF THE INVENTION

Therefore it is a primary object of the present invention to provide a pair of glasses with functions of positioning and reminding, which include a magnetic member arranged at an outer surface of each temple and a striking-and-reminding gel-like member integrally wrapped on an inner surface of the temple by injection. Thereby the glasses can be attached to and fixed on equipment made of iron by the magnetic member while users can find them easily in a messy workplace due to the striking-and-reminding gel-like member.

In order to achieve the above object, a pair of glasses with functions of positioning and reminding according to the present invention includes a frame, a first temple and a second temple pivotally connected to two sides of the frame. Each of the temples includes an inner surface and an outer surface disposed opposite to the inner surface while the two inner surfaces are facing each other.

A top surface is connected to a top edge of the inner surface and a top edge of the outer surface of each temple while a bottom surface is connected to a bottom edge of the inner surface and a bottom edge of the outer surface, and disposed corresponding to the top surface. A magnetic member is mounted on the outer surface while a striking-and-reminding gel-like member is integrally wrapped on the inner surface by injection. An upper edge and a lower edge of the striking-and-reminding gel-like member are respectively extending to form an upper segment and a lower segment which are respectively wrapped on the top surface and the bottom surface.

Preferably, the inner surface is provided with an inner groove for mounting the striking-and-reminding gel-like member.

Preferably, an upper groove and a lower groove are respectively arranged at the top surface and the bottom surface. The inner groove is communicating with the upper groove and the lower groove which are used for mounting the upper segment and the lower segment of the striking-and-reminding gel-like member.

Preferably, the striking-and-reminding gel-like member is made of soft plastics.

The glasses according to the present invention have the following advantages:
(1) When users take off the glasses at the workplace, the glasses are attached to and fixed on equipment made of iron by the magnetic member so that the glasses is stored in place, without scratches and wear.
(2) The striking-and-reminding gel-like member on the inner surface of the first temple and/or the second temple is just located at the position where the user's line of sight is located. In combination with the bright colors that create striking visual effects, users can find out the glasses in a messy workplace easily.
(3) An inner groove is formed on the inner surface of the first temple and/or the second temple for mounting the striking-and-reminding gel-like member. Thus the surface flatness of the inner surface of the first temple and/or the second temple can be ensured.
(4) An upper groove and a lower groove are respectively disposed on the top surface and the bottom surface of the first temple and/or the second temple and are respectively used for mounting the upper segment and the lower segment of the striking-and-reminding gel-like member. Thereby the striking-and-reminding gel-like member is wrapped and fixed on the first temple/the second temple.
(5) Users feel more comfortable while wearing the glasses with their skin in contact with the striking-and-reminding gel-like members. The striking-and-reminding gel-like members made of soft plastics make the glasses much more comfortable.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of an embodiment of a pair of glasses according to the present invention;

FIG. 2 is a perspective view of a temple in an embodiment according to the present invention;

FIG. 3 is a schematic drawing showing a sectional view of an embodiment with temples magnetically attached to equipment made of iron according to the present invention;

FIG. 4 is a schematic drawing showing an embodiment magnetically attached to a side wall of an iron storage cabinet according to the present invention;

FIG. 5 is a schematic drawing showing an embodiment magnetically attached to a wall surface of an iron column according to the present invention.

### DETAILED DESCRIPTION OF THE PREFERRED EMBODIMENT

In order to learn technical features, purposes and functions of the present invention clearly, please refer to the following embodiments with detailed description with reference to related figures and reference numerals.

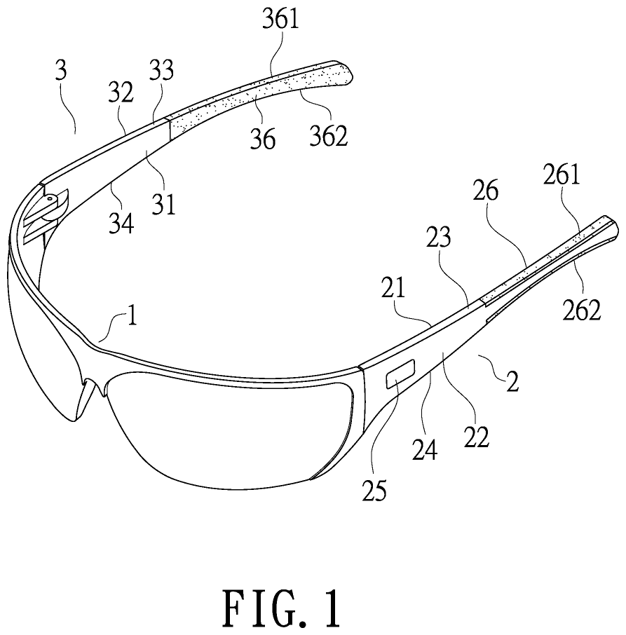

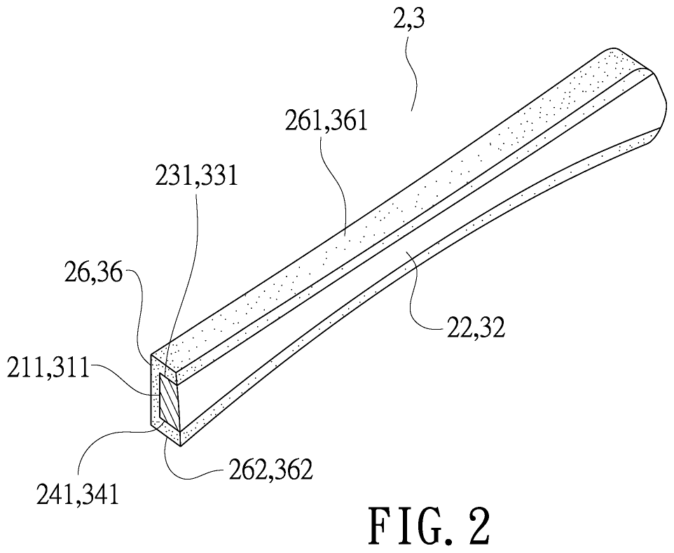

Refer to FIG. 1 and FIG. 2, a pair of glasses with functions of positioning and reminding according to the present invention mainly includes a frame 1, a first temple 2 and a second temple 3. The first temple 2 and the second temple 3 are pivotally connected to two sides of the frame 1 correspondingly.

The first temple 2 is a rod defined by a first inner surface 21, a first outer surface 22 opposite to the first inner surface 21, a first top surface 23, and a first bottom surface 24 disposed corresponding to the top surface 23. The first top surface 23 is connected to a top edge of the first inner surface 21 and a top edge of the first outer surface 22 while the first bottom surface 24 is connected to a bottom edge of the first inner surface 21 and a bottom edge of the first outer surface 22. A first magnetic member 25 is mounted on the first outer surface 22 while a first striking-and-reminding gel-like member 26 is integrally wrapped on the first inner surface 21 by injection. An upper edge and a lower edge of the first striking-and-reminding gel-like member 26 are respectively extending to form a first upper segment 261 and a first lower segment 262 which are respectively put over a part of the first top surface 23, and a part of the first bottom surface 24.

The second temple 3 is disposed corresponding to the second temple 2 and having similar structure. The third temple 3 is a rod defined by a second inner surface 31, a second outer surface 32 opposite to the second inner surface 31, a second top surface 33, and a second bottom surface 34 arranged corresponding to the second top surface 33. The second top surface 33 is connected to a top edge of the second inner surface 31 and a top edge of the second outer surface 32 while the second bottom surface 34 is connected to a bottom edge of the second inner surface 31 and a bottom edge of the second outer surface 32. A second magnetic member 35 is mounted on the second outer surface 32 while a second striking-and-reminding gel-like member 36 is integrally wrapped on the second inner surface 31 by injection. An upper edge and a lower edge of the second striking-and-reminding gel-like member 36 are extending to form a second upper segment 361 and a second lower segment 362 which are respectively wrapped on a part of the second top surface 33, and a part of the second bottom surface 34.

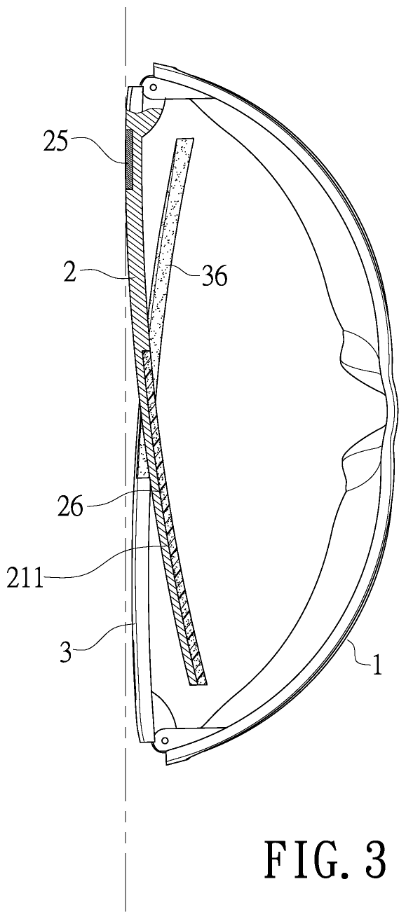

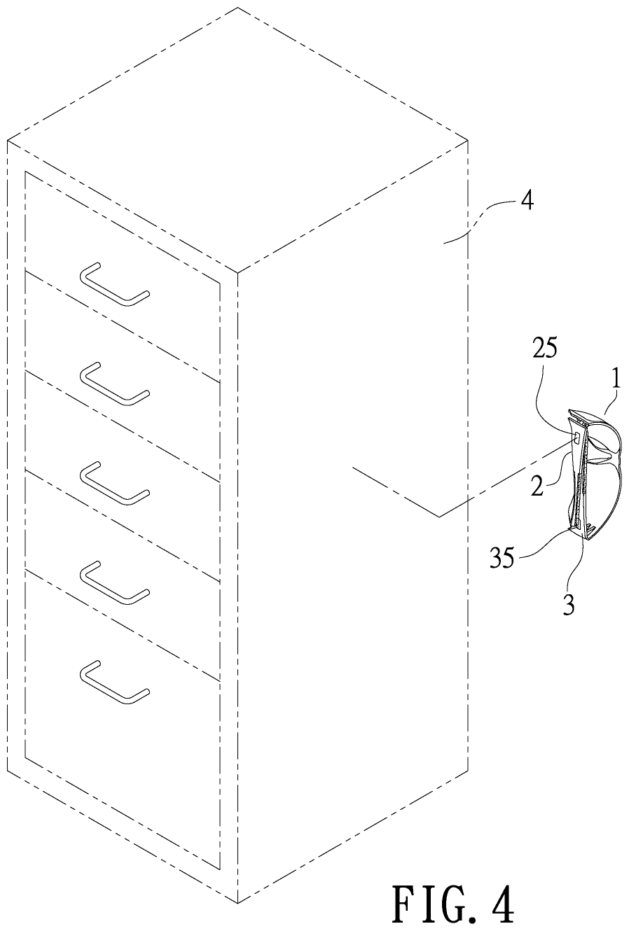

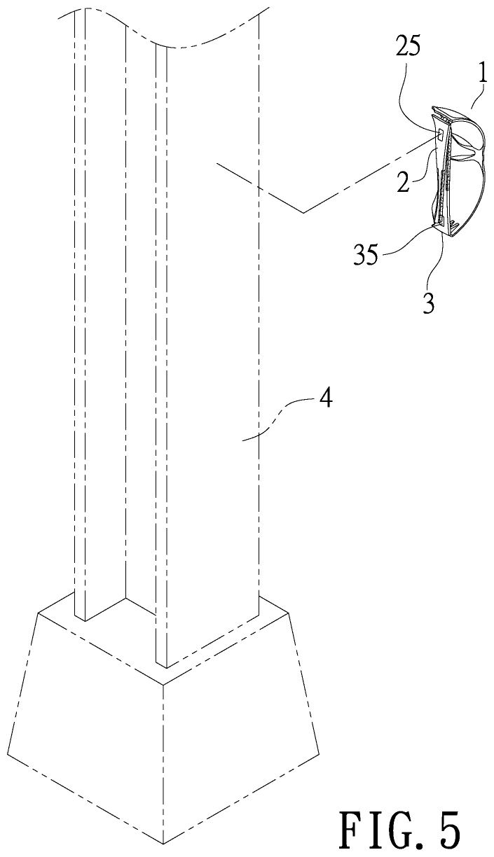

Refer to FIG. 3, FIG. 4 and FIG. 5, when users take off the glasses at a workplace, the glasses are attached to and fixed on equipment made of iron 4 at the workplace by the first magnetic member 25 on the first outer surface 22 of the first temple 2 or the second magnetic member 35 on the second outer surface 32 of the second temple 3. Refer to FIG. 4, the equipment made of iron 4 is an iron storage cabinet and the glasses are attached to and fixed on a side wall of the iron storage cabinet. As shown in FIG. 5, the equipment made of iron 4 is an iron column and the glasses are attached to and fixed on a wall surface of the iron column. Moreover, the first striking-and-reminding gel-like member 26 on the first inner surface 21 of the first temple 2 or the second striking-and-reminding gel-like member 36 on the second inner surface 31 of the second temple 3 has bright colors for creating striking visual effects. Thus users can find the glasses in a messy workplace easily.

In a preferred embodiment of the present invention, the first inner surface 21 of the first temple 2 and the second inner surface 31 of the second temple 3 are respectively provided with a first inner groove 211 and a second inner groove 311 for mounting the first striking-and-reminding gel-like member 26 and the second striking-and-reminding gel-like member 36. The design of the first/second inner groove 211/311 also ensures the surface flatness of the first inner surface 21/the second inner surface 31 of the first temple 2/the second temple 3.

In a preferred embodiment of the present invention, a first upper groove 231 and a second upper groove 331 are respectively disposed on the first top surface 23 of the first temple 2 and the second top surface 33 of the second temple 3 while a first lower groove 241 and a second lower groove 341 are respectively arranged at the first bottom surface 24 of the first temple 2 and the second bottom surface 34 of the second temple 3. The first inner groove 211 is communicating with the first upper groove 231 and the first lower groove 241 of the first temple 2 while the second inner groove 311 is communicating with the second upper groove 331 and the second lower groove 341 of the second temple 3. The first upper groove 231 and the first lower groove 241 of the first temple 2 are respectively used for mounting the first upper segment 261 and the first lower segment 262 of the first striking-and-reminding gel-like member 26 while the second upper groove 331 and the second lower groove 341 of the second temple 3 are respectively used for mounting the second upper segment 361 and the second lower segment 362 of the second striking-and-reminding gel-like member 36. Thereby the first striking-and-reminding gel-like member 26 and the second striking-and-reminding gel-like member 36 are respectively wrapped and secured on the first temple 2 and the second temple 3 firmly.

In a preferred embodiment of the present invention, the first striking-and-reminding gel-like member 26 and the second striking-and-reminding gel-like member 36 are made of soft plastic materials so that users feel more comfortable while wearing the glasses with their skin in contact with the first and second striking-and-reminding gel-like members 26, 36. The first and second striking-and-reminding gel-like members 26, 36 make the glasses much more comfortable due to the soft plastic material.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A pair of glasses with functions of positioning and reminding comprising:
a frame,
a first temple which is pivotally connected to one of the two sides of
the frame and having:
a first inner surface,
a first outer surface opposite to the first inner surface,
a first top surface which is connected to a top edge of the first inner surface and a top edge of the first outer surface;
a first bottom surface which is disposed corresponding to the first top surface and is connected to a bottom edge of the first inner surface and a bottom edge of the first outer surface;
a first magnetic member mounted on the first outer surface; and
a first striking-and-reminding gel-like member which is integrally wrapped on the first inner surface by injection and having an upper edge and a lower edge respectively extending to form a first upper segment and a first lower segment which are respectively wrapped on the first top surface and the first bottom surface; and
a second temple which is pivotally connected to the other side of the frame and having:
a second inner surface,
a second outer surface opposite to the second inner surface;
a second top surface which is connected to a top edge of the second inner surface and a top edge of the second outer surface;
a second bottom surface which is arranged corresponding to the second top surface and is connected to a bottom edge of the second inner surface and a bottom edge of the second outer surface;
a second magnetic member mounted on the second outer surface; and
a second striking-and-reminding gel-like member which is integrally wrapped on the second inner surface by injection and having an upper edge and a lower edge respectively extending to form a second upper segment and a second lower segment which are respectively wrapped on the second top surface and the second bottom surface.

2. The glasses as claimed in claim 1, wherein the first inner surface of the first temple and the second inner surface of the second temple are respectively provided with a first inner groove and a second inner groove; the first inner groove and the second inner groove are respectively used for mounting the first striking-and-reminding gel-like member and the second striking-and-reminding gel-like member.

3. The glasses as claimed in claim 2, wherein a first upper groove and a second upper groove are respectively disposed on the first top surface of the first temple and the second top surface of the second temple while a first lower groove and a second lower groove are respectively arranged at the first bottom surface of the first temple and the second bottom surface of the second temple; the first inner groove is communicating with the first upper groove and the first lower groove while the second inner groove is communicating with the second upper groove and the second lower groove of the second temple; the first upper groove and the first lower groove of the first temple are respectively used for mounting the first upper segment and the first lower segment of the first striking-and-reminding gel-like member while the second upper groove and the second lower groove of the second temple are respectively used for mounting the second upper segment and the second lower segment of the second striking-and-reminding gel-like member.

4. The glasses as claimed in claim 3, wherein the first striking-and-reminding gel-like member and the second striking-and-reminding gel-like member are made of soft plastic materials.

5. The glasses as claimed in claim 1, wherein the first striking-and-reminding gel-like member and the second striking-and-reminding gel-like member are made of soft plastic materials.

6. The glasses as claimed in claim 2, wherein the first striking-and-reminding gel-like member and the second striking-and-reminding gel-like member are made of soft plastic materials.
